(19) United States
(12) Patent Application Publication
(10) Pub. No.: US 2020/0392326 A1
(43) Pub. Date: Dec. 17, 2020

(54) METHODS OF PREPARING CORE-SHELL GRAPHENE/POLYACRYLONITRILE-BASED CARBON NANOSPHERES

(71) Applicant: SABIC Global Technologies B.V., Bergen op Zoom (NL)

(72) Inventors: Chengmeng CHEN, Taiyuan (CN); Guohua SUN, Taiyuan (CN); Fangyuan SU, Taiyuan (CN); Yunyang LIU, Thuwal (SA); Ihab N. ODEH, Thuwal (SA)

(21) Appl. No.: 16/638,173

(22) PCT Filed: Aug. 13, 2018
(86) PCT No.: PCT/IB2018/056086

§ 371 Date: Feb. 11, 2020

(30) Foreign Application Priority Data
Aug. 14, 2017 (CN) 201710692520.7

(51) Int. Cl. C08L 33/20; C08K 3/04; C08F 20/44; C08F 2/06; C08F 265/08

(52) U.S. Cl. CPC C08L 33/20; C08K 3/042; C08F 20/44; B82Y 40/00; C08F 265/08; C08L 2207/53; C08F 2/06

(57) ABSTRACT

A method of producing a carbon core-graphene shell material is disclosed. The method can include obtaining a dispersion comprising a grafted graphene oxide material and a polymerizable carbon material dispersed in a liquid medium, polymerizing the polymerizable carbon material in the dispersion to obtain a grafted graphene oxide coated polymerized carbon material dispersed in the liquid medium, evaporating the liquid medium from the dispersion, and heating the grafted graphene oxide coated polymerized carbon material to obtain the carbon core-graphene shell material.

### CROSS REFERENCE TO RELATED APPLICATIONS

This application claims the benefit of priority of Chinese Patent Application No. 201710692520.7 filed Aug. 14, 2017, which is hereby incorporated by reference in its entirety.

### BACKGROUND OF THE INVENTION

### A. Field of the Invention

The invention generally concerns methods of producing carbon core-graphene shell materials. In particular, the methods concern polymerizing polymerizable carbon material in the presence of graphene oxide to obtain a graphene oxide coated polymerized carbon material. The graphene oxide coated polymerized carbon material can be heated to obtain the carbon core-graphene shell material.

### B. Description of Related Art

Owning to nanostructure scale, high nitrogen-containing groups, lightweight, corrosion resistance, and high thermal stability, polyacrylonitrile (PAN)-based carbon nanospheres have been widely applied in fields such as adsorption, catalyst carrier, coating, and energy storage. By way of example, Chinese Patent Publication No. 101983918 to Li et al. describes preparation of millimeter-scale PAN-based carbon spheres by titrating dropwise a dimethyl sulfoxide (DMSO) solution of polyacrylonitrile into a curing solution, followed by air-oxidization and carbonization. The as-obtained carbon spheres suffer from inferior sphericity, and the slow titrating rate limits commercial scale production. In another example, Chinese Patent Publication No. 101219784 to Yang et al. describes synthesizing PAN-based carbon nanospheres with a particle size ranged from 230 nm to 250 nm by soap-free emulsion polymerization, pre-oxidization, and carbonization. This method suffers from agglomeration of the carbon nanospheres due to cross-linking of —CN bonds. In yet another example, Yang et al. (Carbon 2008, 46, 1816-1818) prepared PAN-based nanospheres with a particle size of about 50 nm, and then coated the nanospheres with titanophosphate to promote monodispersion of the PAN-based carbon nanospheres.

Although various methods to obtain carbon nanospheres are known, the methods can be complicated or be inefficient for commercial production.

### SUMMARY OF THE INVENTION

A discovery has been made that provides a solution to the aforementioned problems associated with making monodispersed carbon nanospheres. The solution lies in an elegant method that utilizes polymerization of a polymerizable carbon material in the presence of graphene oxide to form a graphene oxide coated polymerized carbon material dispersed in a liquid medium. The liquid medium can be removed, and the graphene oxide coated polymerized carbon material can be heated to carbonize the carbon material and form monodispersed carbon core-graphene shell material. In a preferred embodiment, the carbon core-graphene shell material is PAN-based carbon/graphene having high electro conductivity and a high specific surface area. Without wishing to be bound by theory, it is believed that aggregation of nanospheres is reduced due to the graphene oxide shell, which separates the polymerized carbon material (e.g., PAN) nanospheres. During heating to produce the carbon core, the graphene oxide can be reduced thermally to graphene for providing high electro conductivity.

In a particular aspect of the invention, methods of producing carbon core-graphene shell materials are described. A method can include: (a) obtaining a dispersion that can include a grafted graphene oxide material and a polymerizable carbon material dispersed in a liquid medium (e.g., alcohol, preferably methanol, ethanol, propanol, butanol, N-methyl-2-pyrrolidone (NMP), dimethylformamide (DMF), or a combination thereof); (b) polymerizing the polymerizable carbon material in the dispersion to obtain a graphene oxide coated polymerized carbon material dispersed in the liquid medium; (c) evaporating the liquid medium from the dispersion; and (d) heating the graphene oxide coated polymerized carbon material to obtain the carbon core-graphene shell material. In a preferred instance, the carbon material can include acrylonitrile (AN), the polymerized carbon material can be polyacrylonitrile (PAN), and the carbon core can be a PAN-based carbon core. Step (b) polymerization can include combining a polymerization initiator (e.g., azobisisobutyronitrile (AIBN), potassium persulfate (K₂S₂O₈), sodium persulfate (Na₂S₂O₈), benzoyl peroxide, or the like) with the dispersion to initiate polymerization of the polymerizable carbon material. Evaporating the liquid medium can include freeze-drying the dispersion. The heating step (d) can include subjecting the graphene oxide coated polymerized carbon material to a temperature of 150° C. to 450° C. (e.g., preferably 200° C. to 400° C., or more preferably 250° C. to 350° C.), in the presence of an oxygen source, preferably air, to oxidize the material, and subjecting the oxidized material to a temperature of 700° C. to 1500° C. in the presence of an inert gas to obtain the carbon core-graphene shell material. The carbon core-graphene shell material can be in particulate form that includes a plurality of carbon core-graphene shell nanostructures. The nanostructure can be nanospheres having an average diameter of 50 nm to 1000 nm. In a preferred embodiment: the polymerizable carbon material is acrylonitrile (AN), the polymerized carbon material is polyacrylonitrile (PAN), and the carbon core is a PAN-based carbon core; the polymerization step (b) includes combining a polymerization initiator with the dispersion to initiate polymerization of the AN; the evaporation step (c) includes freeze-drying the dispersion; and the heating step (d) includes subjecting the graphene oxide coated PAN material to a temperature of 150° C. to 450° C., preferably 200° C. to 400° C., or more preferably 250° C. to 350° C., in the presence of an oxygen source, preferably air, to oxidize the material; and subjecting the oxidized material to a temperature of 700° C. to 1500° C. in the presence of an inert gas to obtain the PAN-based carbon core-graphene shell material. The grafted graphene oxide material in step (a) can have a lamellar thickness of 1 to 10 layers and a sheet size of 100 nm to 5000 nm. The grafted graphene oxide material can be a nitrogen-containing grafted graphene oxide material. Non-limiting examples of nitrogen-containing grafted graphene oxide materials include an amine or amide-containing grafted graphene oxide material. Non-limiting examples of amine or amide-containing grafted graphene oxide material can include allylamine, vinylamine, 4-(vinyloxy)aniline, N-(2-aminoethyl)acrylamide, N-(3-aminopropyl)acrylamide, N-(6-aminohexyl)acrylamide, or N-(4-aminophenyl)acrylamide. Nitrogen-containing grafted graphene oxide material can be obtained by dissolving graphene oxide and a nitrogen-containing grafting agent in a solvent to obtain a solution, heating the solution to graft the grafting agent to the graphene oxide, and optionally removing the solvent. In some embodiments, the obtained carbon core-graphene shell material can be activated, preferably by being treated with a base.

In another aspect of the present invention, a carbon core-graphene shell material made by the process of the present invention is described. The material can be comprised in an energy storage device, a coating material, or a catalyst for a chemical reaction.

In yet another aspect of the present invention, a plurality of monodisperse polyacrylonitrile (PAN)-based carbon core-graphene shell nanostructures is described. Each nanostructure can include a PAN-based carbonized core and a graphene shell that substantially encompasses the core. The nanostructures can include nanospheres having an average diameter of 50 nm to 1000 nm. The nanostructures can be included in an energy storage device, a coating material, or a catalyst for a chemical reaction. In a preferred instance, the nanostructures are included in an electrode of the energy storage device.

In the context of the present invention, 20 embodiments are described. Embodiment 1 is a method of producing a carbon core-graphene shell material, the method comprising: (a) obtaining a dispersion comprising a grafted graphene oxide material and a polymerizable carbon material dispersed in a liquid medium; (b) polymerizing the polymerizable carbon material in the dispersion to obtain a grafted graphene oxide coated polymerized carbon material dispersed in the liquid medium; (c) evaporating the liquid medium from the dispersion; and (d) heating the grafted graphene oxide coated polymerized carbon material to obtain the carbon core-graphene shell material. Embodiment 2 is the method of embodiment 1, wherein the polymerizable carbon material is acrylonitrile (AN), the polymerized carbon material is polyacrylonitrile (PAN), and the carbon core is a PAN-based carbon core. Embodiment 3 is the method of any one of embodiments 1 to 2, wherein the polymerization step (b) comprises combining a polymerization initiator with the dispersion to initiate polymerization of the polymerizable carbon material. Embodiment 4 is the method of embodiment 3, wherein the polymerization initiator is azobisisobutyronitrile (AIBN), potassium persulfate (K₂S₂O₈), sodium persulfate (Na₂S₂O₈), or benzoyl peroxide, or combinations thereof. Embodiment 5 is the method of any one of embodiments 1 to 4, wherein the evaporation step (c) comprises freeze-drying the dispersion. Embodiment 6 is the method of any one of embodiments 1 to 5, wherein the heating step (d) comprises: (1) subjecting the graphene oxide coated polymerized carbon material to a temperature of 150° C. to 450° C., preferably 200° C. to 400° C., or more preferably 250° C. to 350° C., in the presence of an oxygen source, preferably air, to oxidize the material; and (2) subjecting the oxidized material to a temperature of 700° C. to 1500° C. in the presence of an inert gas to obtain the carbon core-graphene shell material. Embodiment 7 is the method of embodiment 1, wherein: the polymerizable carbon material is acrylonitrile (AN), the polymerized carbon material is polyacrylonitrile (PAN), and the carbon core is a PAN-based carbon core; the polymerization step (b) comprises combining a polymerization initiator with the dispersion to initiate polymerization of the AN; the evaporation step (c) comprises freeze-drying the dispersion; and the heating step (d) comprises: (1) subjecting the graphene oxide coated PAN material to a temperature of 150° C. to 450° C., preferably 200° C. to 400° C., or more preferably 250° C. to 350° C., in the presence of an oxygen source, preferably air, to oxidize the material; and (2) subjecting the oxidized material to a temperature of 700° C. to 1500° C. in the presence of an inert gas to obtain the PAN-based carbon core-graphene shell material. Embodiment 8 is the method of any one of embodiments 1 to 7, wherein the grafted graphene oxide material is a nitrogen-containing grafted graphene oxide material. Embodiment 9 is the method of embodiment 8, wherein the nitrogen-containing grafted graphene oxide material is an amine or amide-containing grafted graphene oxide material selected from allylamine, vinylamine, 4-(vinyloxy)aniline, N-(2-aminoethyl)acrylamide, N-(3-aminopropyl)acrylamide, N-(6-aminohexyl)acrylamide, or N-(4-aminophenyl)acrylamide. Embodiment 10 is the method of any one of embodiments 8 to 9, wherein the nitrogen containing grafted graphene oxide material is obtained by dissolving graphene oxide and a nitrogen containing grafting agent in a solvent to obtain a solution, heating the solution to graft the grafting agent to the graphene oxide, and optionally removing the solvent. Embodiment 11 is the method of any one of embodiments 1 to 10, wherein the grafted graphene oxide material in step (a) has a lamellar thickness of 1 to 10 layers and a sheet size of 100 nm to 5000 nm. Embodiment 12 is the method of any one of embodiments 1 to 11, wherein the liquid medium is an N-methyl-2-pyrrolidone (NMP), dimethylformamide (DMF), an alcohol, preferably methanol, ethanol, propanol, or butanol, or any combination thereof. Embodiment 13 is the method of any one of embodiments 1 to 12, wherein the obtained carbon core-graphene shell material is in particulate form comprising a plurality of carbon core-graphene shell nanostructures. Embodiment 14 is the method of embodiment 13, wherein the plurality of nanostructures are nanospheres having an average diameter of 60 nm to 1000 nm. Embodiment 15 is the method of any one of embodiments 1 to 14, wherein the obtained carbon core-graphene shell material is activated, preferably by being treated with a base.

Embodiment 16 is a carbon core-graphene shell material made by the process of any one of embodiments 1 to 15. Embodiment 17 is the material of embodiment 16, comprised in an energy storage device, a coating material, or a catalyst for a chemical reaction. Embodiment 18 is a plurality of monodisperse polyacrylonitrile (PAN)-based carbon core-graphene shell nanostructures, each nanostructure comprising a PAN-based carbonized core and a graphene shell that substantially encompasses the core. Embodiment 19 is the plurality of monodisperse PAN-based carbon core-graphene shell nanostructures of embodiment 18, wherein the nanostructures are comprised in an energy storage device, a coating material, or a catalyst for a chemical reaction. Embodiment 20 is the plurality of monodisperse PAN-based carbon core-graphene shell nanostructures of embodiment 19, wherein the nanostructures are comprised in an energy storage device, preferably in an electrode of the energy storage device.

The following includes definitions of various terms and phrases used throughout this specification.

“Monodispersed particles” refers to a plurality of particles that have not aggregated together during heating (e.g., the air-oxidation and carbonization steps).

“Nanostructure” or “nanomaterial” refer to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 1000 nm (e.g., a first dimension is 1 to 1000 nm in size, a second dimension is 1 to 1000 nm in size, and a third dimension is 1 to 1000 nm in size). The shape of the nanostructure can be of a wire, a particle (e.g., having a substantially spherical shape), a rod, a tetrapod, a hyper-branched structure, a tube, a cube, or mixtures thereof. “Nanoparticles” include particles having an average diameter size of 1 to 1000 nanometers.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The methods of the present invention can “comprise,” “consist essentially of” or “consist of” particular ingredients, components, compositions, etc. disclosed throughout the specification. With respect to the transitional phase “consisting essentially of” in one non-limiting aspect, a basic and novel characteristic of the methods of the present invention are their abilities to produce monodispersed carbon core-graphene shell materials.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 depicts a schematic of a method of the present invention to produce carbon core-graphene shell nanomaterials.

FIG. 2 depicts a schematic of a mechanism for inhibiting the aggregation of carbon core nanomaterials.

FIG. 3 is a scanning electron microscopy (SEM) image of polyacrylonitrile nanospheres.

FIG. 4 is a SEM image of polyacrylonitrile nanospheres coated with grafted graphene oxide.

FIGS. 5A and 5B are SEM images of the carbonized polyacrylonitrile nanospheres.

FIGS. 6A-6D are transmission electron microscopy (TEM) images of carbonized polyacrylonitrile nanospheres.

FIG. 7 is a TEM image of carbonized polyacrylonitrile nanospheres.

FIGS. 8A and 8B are TEM images of the carbon core-graphene shell materials of the present invention.

FIG. 9 shows the relationship of conductivity versus pressure for carbonized nanospheres (square monikers) absent of a graphene coating, and carbon core-graphene shell nanomaterials of the present invention (circle monikers).

While the invention is susceptible to various modifications and alternative forms, specific embodiments thereof are shown by way of example in the drawings. The drawings may not be to scale.

### DETAILED DESCRIPTION OF THE INVENTION

A discovery has been made that provides a solution to at least some of the problems associated with making carbon nanospheres. The solution is premised in an emulsion polymerization method to form a graphene oxide coated polymerized carbon material. This material can then be dried and converted into the carbon core-graphene shell material of the present invention through heat treatment. The carbon core-graphene shell material can be PAN-based carbon core-graphene nanostructures having high electro conductivity and high specific surface area. Notably, the methods of the present invention can be used to make a plurality of monodispersed PAN-based carbon core-graphene shell nanostructures.

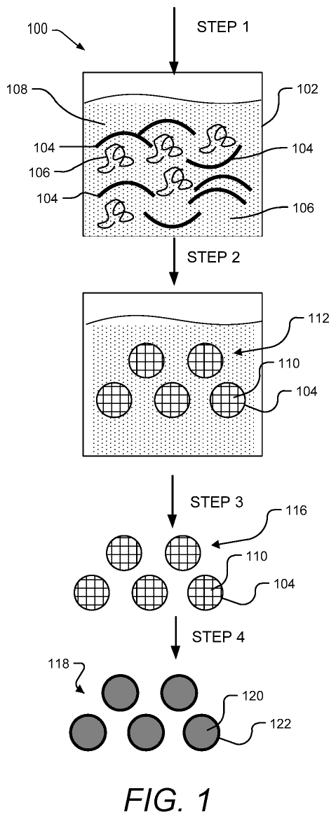

These and other non-limiting aspects of the present invention are discussed in further detail in the following sections with reference to FIG. 1.

### A. Preparation of Carbon Core-Graphene Shell Nanostructures

FIG. 1 is a schematic of a method for preparing carbon core-graphene shell nanostructures. The method can include one or more steps that can be used in combination to make monodispersed carbon core-graphene shell nanostructures. These nanostructures can be used in a variety of manners, non-limiting examples of which include energy storage devices, a coating material, or a catalyst for a chemical reaction.

Referring to method 100 of FIG. 1, in step 1 of the method a dispersion 102 that includes a grafted graphene oxide material 104 and a polymerizable carbon material 106 dispersed in a liquid medium 108 can be obtained. The grafted graphene oxide material 104 can be prepared as described in the Materials Section below, the Examples Section, or obtained from a commercial vendor. The polymerizable carbon material 106 can be any polymerizable carbon material, or those described in the Materials Section below, and can be obtained from a commercial vendor. The liquid medium 108 can be NMP, DMF, or any alcohol. Non-limiting examples of alcohols include methanol, ethanol, propanol, or butanol, or combinations thereof. In one instance, the dispersion includes a nitrogen-containing grafted graphene oxide material and the polymerizable carbon material is acrylonitrile. The grafted graphene oxide material and polymerizable carbon material can be added to the liquid medium under mechanical stirring or sonication (e.g., ultra-sonication) until the dispersion is homogeneous or substantially homogeneous at 25 to 35° C., or about 30° C. Ultrasonic dispersion in water can prevent the grafted graphene oxide material and the polymerizable carbon material from aggregating to get a homogeneous dispersion.

A mass ratio of the grafted graphene oxide material 104, the polymerizable carbon material 106, and the liquid medium 108 can range from 1:12:130, 1:14:135, 1:16:160, 1:17:165, 1:20:200, 1:27:266 or 1:30:200. The mass ratio of the grafted graphene oxide material 104 to the polymerizable carbon material 106 can range from 1:12 to 1:30, or about 1:12, 1:14, 1:15, 1:16, 1:17, 1:18, 1:19, 1:20, 1:21, 1:22, 1:23, 1:24, 1:25, 1:26, 1:27, 1:28, 1:29, 1:30 or any ratio there between. The mass ratio of the grafted graphene oxide material 104 to the liquid medium 108 can range from 1:120 to 1:300, or 1:120, 1:150, 1:175, 1:200, 1:225, 1:250, 1:275, 1:300 or any ratio there between.

In step 2, polymerizable carbon material 106 in the dispersion can be subjected polymerizing conditions such that polymerized carbon material 110 and grafted graphene oxide material 104 self-assemble to form grafted graphene oxide coated polymerized carbon material 112. The grafted graphene oxide coated polymerized carbon material 112 has a polymerized carbon material core 110 and grafted graphene oxide shell 104. Polymerizing conditions can include heating the homogeneous dispersion to 60 to 70° C., or about 65° C. under an inert atmosphere and adding a polymerization initiator 114 to the dispersion. Any radical initiator can be used. Non-limiting examples of radical initiators include AIBN, K₂S₂O₈, Na₂S₂O_{8,} or benzoyl peroxide, and the like. A mass ratio of polymerizable carbon material to initiator can be 1:200 to 1:350, or 1:200, 1:225, 1:250, 1:275, 1:300, 1:325, 1:350 or any ratio there between. The dispersion can be held at 60 to 70° C. until polymerization is considered complete (e.g., about 1 to 10 hours).

In step 3, method 100, liquid medium 108 can be removed from the dispersion using known evaporative techniques. Non-limiting evaporation methods include freeze drying, vacuum drying, vacuum distillation or the like. In a preferred embodiment, liquid medium 108 is removed through freeze drying. By way of example, the dispersion of polymer coated grafted graphene oxide 112 can be placed in a freeze dryer and subjected to conditions sufficient to remove all, or substantially all, of liquid medium 108 (e.g. 1 to 50 hours, or about 25 hours) and produce dried grafted graphene oxide coated polymerized carbon material 116. Freeze drying conditions can include a temperature of −45° C. to −50° C., or about −44° C. and a vacuum of 15 Pa to 18 Pa, or about 17 Pa. The dried polymer coated grafted graphene oxide can be in powder form.

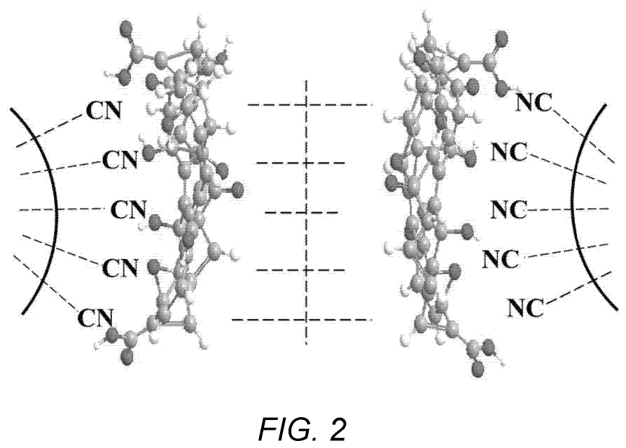

In step 4 of method 100, dried grafted graphene oxide coated polymerized carbon material 116 can be heated to produce carbon core-graphene shell nanostructures 118. Heating can include heating dried grafted graphene oxide coated polymerized carbon material 116 in an oxidative atmosphere (e.g., air) followed by heating in an inert atmosphere to effect carbonization and to convert the grafted graphene oxide to grafted graphene. Oxidative heat-treating can include subjecting dried grafted graphene oxide coated polymerized carbon material 116 to a temperature of 80° C. to 450° C., 200° C. to 400° C., or 250° C. to 350° C., or 150° C., 175° C., 200° C., 225° C., 250° C., 275° C., 300° C., 325° C., 350° C., 375° C., 400° C., 425° C., 450° C. or any range or value there between in the presence of an oxygen source to produce oxidized material 120. A rate of heating can range from 0.1 to 10° C. per minute, or 2 to 8° C. per minute or about 5° C. per minute. A flow of inert gas (e.g., argon) can be 40 mL per minute (mLmin⁻¹) to 100 mLmin⁻¹ or 50 mL min⁻¹ to 80 mL min⁻¹, or about 80 mLmin⁻¹. In some embodiments, the heating is performed in two stages. In the first stage, dried grafted graphene oxide coated polymerized carbon material 116 is heated to 70° C. to 90° C., or about 80° C. at a heating rate of 1 to 8° C./min, or about 5° C./min. In stage two, the heat can be increased to 250° C. to 450° C. at a rate of 0.1 to 1° C./min, or about 270° C. at a heating rate of 0.5 to 0.7° C./min. A rate of heating can range from 1 to 10° C. per minute, or 2 to 8° C. per minute or about 5° C. per minute. A flow of inert gas (e.g., argon) can be 20 mL per minute (mLmin⁻¹) to 50 mLmin⁻¹ or 25 mL min⁻¹ to 45 mL min^{'1}, or about 40 mLmin⁻¹. Heating grafted graphene oxide coated polymerized carbon material 116 in the presence of an oxygen source can oxidize the polymerized carbon material, which facilitates carbonization. Non-limiting examples of an oxygen source is oxygen gas, air, oxygen enriched air or the like. Without wishing to be bound by theory, it is believed that the grafted graphene oxide coating inhibits aggregation of the nanospheres under oxidizing conditions. FIG. 2 depicts a schematic of the mechanism for reducing cross-linking and aggregation of the nanospheres.

Heat-treating of oxidized material can include subjecting the oxidized material to a temperature of 700° C. to 1500° C., 800° C. to 1200° C., 900° C. to 1100° C., or 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C. or any range or value there between in the presence of an inert gas (e.g., argon, nitrogen, helium, etc.) to produce carbon core-graphene shell nanostructures 118. The heat treating can carbonize the polymerized carbon material. A rate of heating can range from 1 to 10° C. per minute, or 2 to 8° C. per minute or about 5° C. per minute. A flow of inert gas (e.g., argon) can be 20 mL per minute (mLmin⁻¹) to 50 mLmin' or 25 mL min' to 45 mL min', or about 40 mLmin'. Carbon core-graphene shell nanostructures 118 can be cooled to room temperature and collected.

The resulting carbon core-graphene shell nanostructures 118 can include a carbon core 120 and graphene shell 122. In some embodiments, carbon core-graphene shell nanostructures 118 have an average particle diameter of 60 nm to 1000 nm, preferably 100 nm to 300 nm, or any value greater than, equal to, or between any two of 60, 100, 150, 200, 250, 300, 350, 400, 450, 500, 550, 600, 650, 700, 750, 800, 850, 900, 950, and 1000 nm.

### B. Materials

Grafted graphene oxide can be obtained from using the method described below. Graphene oxide can be obtained from various commercial sources or prepared as exemplified in the Example section by modification of known literature methods (e.g., Hummers et al., J. Am. Chem. Soc., 1958, 80, 1339-1339, which is incorporated by reference). The graphene oxide can have a lamellar thickness of 1-15 layers (1, 2, 3, 4, 5, 6, 7, 8, 9, 10, 11, 12, 13, 14, 15 layers) and a sheet size of 400 to 600 nm, or about 500 nm. Grafting agents and solvents can be obtained from various commercial sources such as Sigma-Aldrich® (U.S.A.).

The grafted graphene oxide can be prepared by subjecting a composition that includes a solvent, graphene oxide, and a grafting agent to conditions sufficient to produce a grafted graphene oxide, and then removing the grafted graphene oxide from the solvent. The grafting agent can include amines and amides. Non-limiting examples of amines and amides include allylamine, vinylamine, 4-(vinyloxy)aniline, N-(2-aminoethyl)acrylamide, N-(3-aminopropyl)acrylamide, N-(6-aminohexyl)acrylamide, or N-(4-aminophenyl)acrylamide, or mixtures thereof. Suitable solvents include dimethylformamide (DMF), dimethylacetamide

(DMAc), dimethyl sulfoxide (DMSO), acetonitrile, alcohols, ethanol, water, or any combination thereof. The mass ratio of the graphene oxide, the grafting reactant, and the organic solvent can be 1:2:300, 1:50:150, 1:100:380, or any range there between. The mass ratio of the graphene oxide and the grafting agent can be 1:5 to 1:20, or about 1:5, 1:10, 1:15, 1:20, or 1:10. The grafting agent and graphene oxide can be added to the organic solvent under agitation to form a dispersion. In a preferred instance, graphene oxide, allylamine, and dimethylformamide are used. The dispersion can be heated to 50° C. to 150° C., more preferably for 75° C. to 100° C., or about 50° C., 55° C., 60° C., 65° C., 70° C., 75° C., 80° C., 85° C., 90° C., 95° C., 100° C., 110° C., 115° C., 120° C., 125° C., 130° C., 135° C., 140° C., 145° C., or 150° C. and held at this temperature until a sufficient amount of the grafting agent reacts with the graphene oxide (e.g., 8 to 12 hours, or about 8, 9, 10 11, 12 hours). During heating, the grafting agent can be completely or substantially solubilized (e.g., dissolved) in the solvent, while the graphene oxide is suspended or dispersed in the solvent.

Polymerizable carbon material can include any carbon material that can be polymerized and then carbonized at high temperatures. Non-limiting examples of polymerizable carbon material includes acrylonitrile, vinyl alcohol, methylmethacrylate, vinyl chloride, vinylidene chloride, melamine, and the like. In a preferred embodiment, acrylonitrile is used.

### C. Uses of the Carbon Core-Graphene Shell Material

The carbon core-graphene shell material of the present invention can be used in a variety of energy storage applications or devices (e.g., fuel cells, batteries, supercapacitors, lithium-ion battery cells or any other battery cell, system or pack technology), optical applications, coating applications, and/or controlled release applications, or a catalyst for chemical reactions. The term “energy storage device” can refer to any device that is capable of at least temporarily storing energy provided to the device and subsequently delivering the energy to a load. Furthermore, an energy storage device may include one or more devices connected in parallel or series in various configurations to obtain a desired storage capacity, output voltage, and/or output current. Such a combination of one or more devices may include one or more forms of stored energy. By way of example, a battery can include the previously described carbon core-graphene shell material (e.g., on an anode electrode and/or a cathode electrode). In another example, the energy storage device can also, or alternatively, include other technologies for storing energy, such as devices that store energy through performing chemical reactions (e.g., fuel cells), trapping electrical charge, storing electric fields (e.g., capacitors, variable capacitors, ultracapacitors, and the like), and/or storing kinetic energy (e.g., rotational energy in flywheels).

In some particular instances, the carbon core-graphene shell material of the present invention can be used in articles of manufacture that have curved surfaces, flexible surfaces, deformable surfaces, etc. Non-limiting examples of such articles of manufacture include virtual reality devices, augmented reality devices, fixtures that require flexibility such as adjustable mounted wireless headsets and/or ear buds, communication helmets with curvatures, medical patches, flexible identification cards, flexible sporting goods, packaging materials and/or applications where the presence of a bendable energy source simplifies final product design, engineering, and/or mass production.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Synthesis of Grafted Graphene Oxide

Graphene oxide was made using a modified Hummer' s method. The prepared graphene oxide (3 g, lamellar thickness of 1 layer, sheet size of 500 nm) and allylamine grafting agent (30 g) were dissolved in DMF (900 g) and then heated to 100° C., and held for 48 h. After cooling naturally to room temperature (about 20° C. to about 25° C.), the reaction mixture was centrifuged and washed with ethanol 3 times to obtain grafted graphene oxide.

### Example 2

### Synthesis of Carbon Core-Graphene Shell Material of the Present Invention

Acrylonitrile (81 g), grafted graphene oxide (3 g, Example 1, with a lamellar thickness of 1 layer and a sheet size of 500 nm) and ethanol (800 g) were mixed at 25° C. by ultra-sonication under a power of 500 W for 2 h to obtain a homogenous suspension. Subsequently, the obtained suspension was heated to 62° C. at a heating rate of 3° C./min under argon atmosphere with a flow rate of 20 ml/min. AIBN (0.25 g) was injected into the suspension to initiate the polymerization reaction. The solution was held for 6 h to obtain the graphene oxide coated PAN-based material, which were spherical in nature. The suspension of graphene oxide coated PAN-based nanospheres was placed in a freeze dryer, and freeze dried at a temperature of −40° C. and a vacuum of 15 Pa for 24 h to obtain powered graphene oxide coated PAN-based nanospheres. Powdered graphene oxide doped PAN-based nanospheres (1 g) were placed in a tube furnace and then heated from room temperature to 80° C. at a heating rate of 3° C./min, then to 250° C. at a heating rate of 0.5° C./min under air atmosphere with a flow rate of 80-100 ml/min and then kept at this temperature for 3 h. The air atmosphere was changed to argon atmosphere with a flow rate of 40 ml/min, and the powdered material was heated continuously to 700° C. at a heating rate of 3° C./min. After cooling naturally to room temperature, the monodispersed graphene coated PAN-based carbon nanospheres with an average particle diameter of 600 nm were obtained.

### Example 3

### Synthesis of Carbon Core-Graphene Shell Material of the Present Invention

Acrylonitrile (81 g), grafted graphene oxide (4 g, prepared using the procedure of Example 1, with a lamellar thickness of 2 layer and a sheet size of 600 nm) and ethanol (800 g) were mixed at 26° C. by ultra-sonication under a power of 500 W for 3 h to obtain a homogenous suspension. Subsequently, the obtained suspension was heated to about 63° C. at a heating rate of 4° C./min under argon atmosphere with a flow rate of 25 ml/min. AIBN (0.25 g) was injected into the suspension to initiate the polymerization reaction. The solution was held for 7 h to obtain the graphene oxide coated PAN-based material, which were spherical in nature. The suspension of graphene oxide coated PAN-based nanospheres was placed in a freeze dryer, and freeze dried at a temperature of −42° C. and a vacuum of 16 Pa for 26 h to obtain powered graphene oxide coated PAN-based nanospheres. Powdered graphene oxide doped PAN-based nanospheres (1 g) were placed in a tube furnace and then heated from room temperature to 80° C. at a heating rate of 4° C./min, then to 260° C. at a heating rate of 0.6° C./min under air atmosphere with a flow rate of 80 ml/min and then kept at this temperature for 4 h. The air atmosphere was changed to argon atmosphere with a flow rate of 50 ml/min. The powdered material was heated continuously to 800° C. at a heating rate of 4° C./min. After cooling naturally to room temperature, the monodispersed graphene coated PAN-based carbon nanospheres with a particle diameter of 650 nm were obtained.

### Example 4

### Synthesis of Carbon Core-Graphene Shell Material of the Present Invention

Acrylonitrile (81 g), grafted graphene oxide (5 g, prepared using the procedure of Example 1, with a lamellar thickness of 3 layer and a sheet size of 700 nm) and ethanol (800 g) were mixed at 27° C. by ultra-sonication under a power of 600 W for 2.5 h to obtain a homogenous suspension. Subsequently, the obtained suspension was heated to about 64° C. at a heating rate of 5° C./min under argon atmosphere with a flow rate of 30 ml/min. AIBN (0.25 g) was injected into the suspension to initiate the polymerization reaction. The solution was held for 7 h to obtain the graphene oxide coated PAN-based material, which were spherical in nature. The suspension of graphene oxide coated PAN-based nanospheres was placed in a freeze dryer, and freeze dried at a temperature of −44° C. and a vacuum of 17 Pa for 28 h to obtain powered graphene oxide coated PAN-based nanospheres. Powdered graphene oxide doped PAN-based nanospheres (1 g) were placed in a tube furnace and then heated from room temperature to 80° C. at a heating rate of 5° C./min, then to 270° C. at a heating rate of 0.7° C./min under air atmosphere with a flow rate of 80 ml/min and then kept at this temperature for 5 h. The air atmosphere was changed to argon atmosphere with a flow rate of 40 ml/min. The powdered material was heated continuously to 900° C. at a heating rate of 5° C./min. After cooling naturally to room temperature, the monodispersed graphene coated PAN-based carbon nanospheres with a particle diameter of 700 nm are obtained.

### Example 5

### Synthesis of Carbon Core-Graphene Shell Material of the Present Invention

Acrylonitrile (81 g), grafted graphene oxide (6 g, prepared using the procedure of Example 1, with a lamellar thickness of 10 layer and a sheet size of 1200 nm) and ethanol (800 g) were mixed at 30° C. by ultra-sonication under a power of 700 W for 3 h to obtain a homogenous suspension. Subsequently, the obtained suspension was heated to about 65° C. at a heating rate of 3° C./min under argon atmosphere with a flow rate of 30 ml/min. AIBN (0.4 g) was injected into the suspension to initiate the polymerization reaction. The solution was held for 7 h to obtain the graphene oxide coated PAN-based material, which were spherical in nature. The suspension of graphene oxide coated PAN-based nanospheres was placed in a freeze dryer, and freeze dried at a temperature of −43° C. and a vacuum of 15 Pa for 28 h to obtain powered graphene oxide coated PAN-based nanospheres. Powdered graphene oxide doped PAN-based nanospheres (1 g) were placed in a tube furnace and then heated from room temperature to 80° C. at a heating rate of 4° C./min, then to 300° C. at a heating rate of 0.6° C./min under air atmosphere with a flow rate of 100 ml/min and then kept at this temperature for 5 h. The air atmosphere was changed to argon atmosphere with a flow rate of 60 ml/min. The powdered material was heated continuously to 800° C. at a heating rate of 5° C./min. After cooling naturally to room temperature, the monodispersed graphene coated PAN-based carbon nanospheres with a particle diameter of 1000 nm were obtained.

### Example 6

### Characterization of Materials and Products of the Present Invention

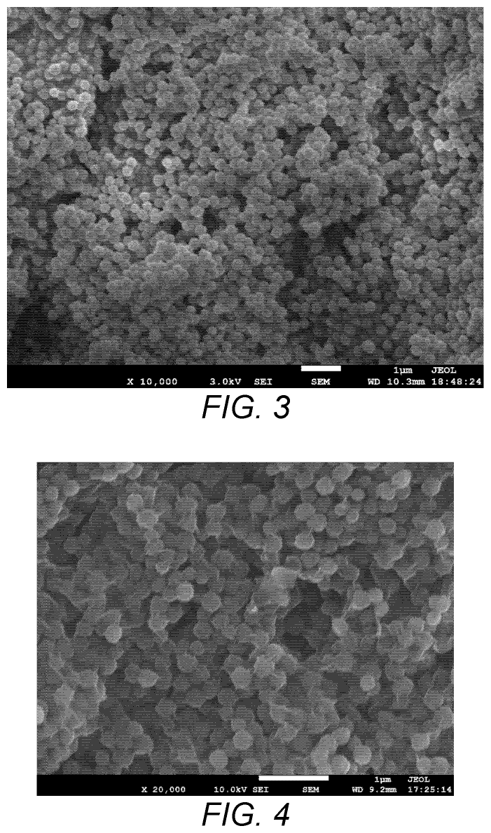

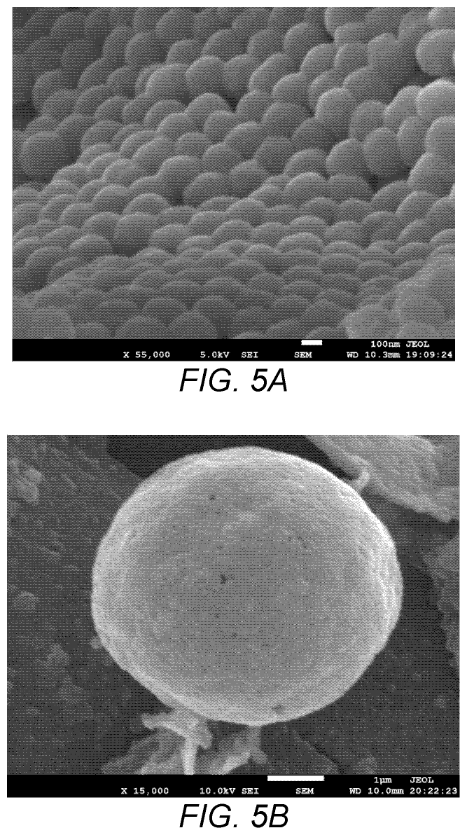

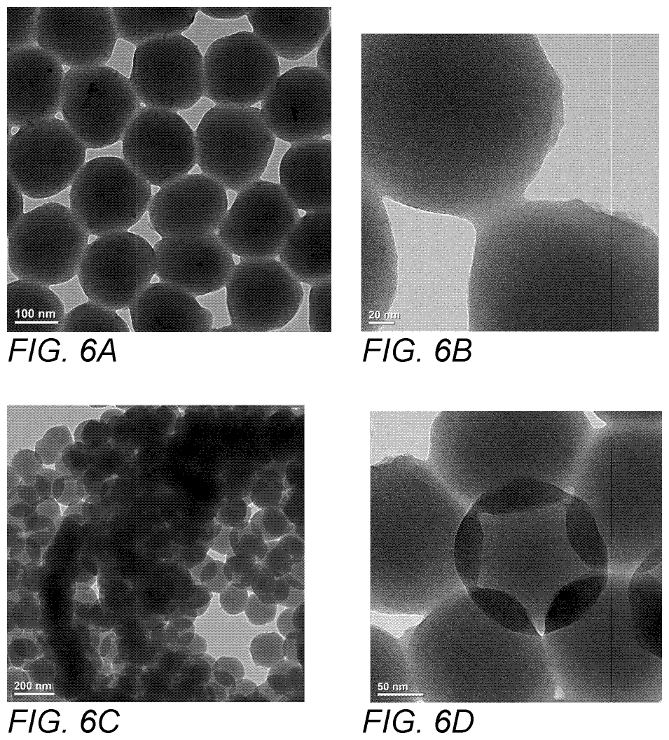

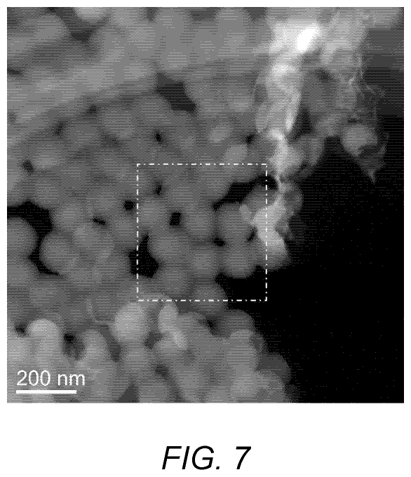

Scanning electron microscopy (SEM) images of the PAN-nanospheres (PNSs), coated PNSs, and carbon core-graphene shell nanomaterials of the present invention (Example 2) were obtained using a JEOL JSM 7401F, (JEOL, JAPAN). Transmission electron microscopy (TEM) images of the PAN-nanospheres (PNSs), coated PNSs, and carbon core-graphene shell nanomaterials of the present invention were obtained using a TEM, FEI Tecnai G2F20 (FEI, USA). FIG. 3 is a SEM image of polyacrylonitrile nanospheres. FIG. 4 is a SEM image of polyacrylonitrile nanospheres coated with grafted graphene oxide. FIGS. 5A and 5B are SEM images of the carbonized polyacrylonitrile nanospheres. FIGS. 6A-6D are TEM images of carbonized polyacrylonitrile nanospheres. FIG. 7 is a TEM image of carbonized polyacrylonitrile nanospheres used for EDS analysis. Table 1 lists the EDS data. FIGS. 5-7 have no graphene coating.

TABLE 1

| Element | Element ratio (%) |
|---|---|
| C | 89 |
| N | 6 |
| O | 5 |

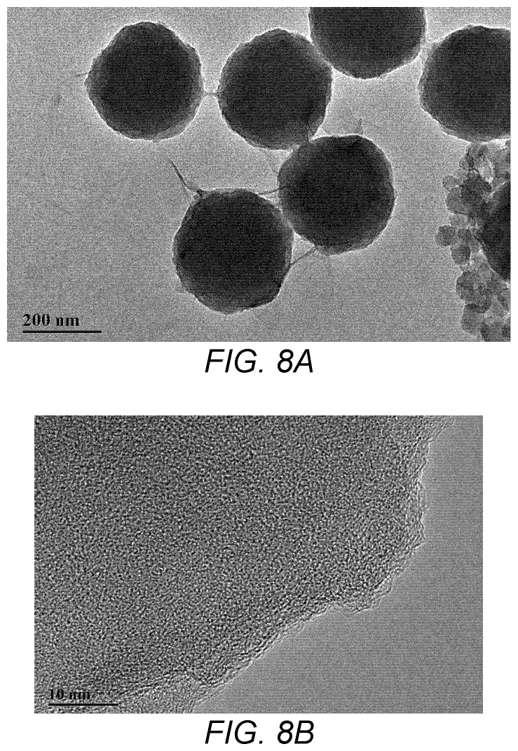

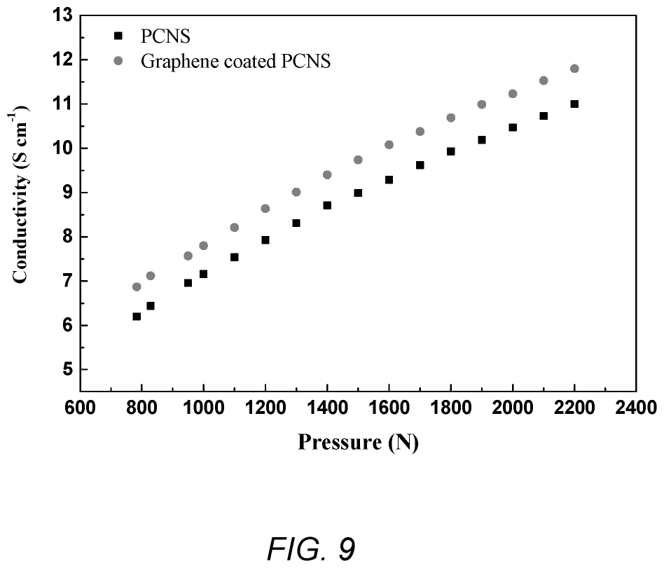

FIGS. 8A and 8B are TEM images of the carbon core-graphene shell materials of the present invention. FIG. 9 shows the relationship of conductivity versus pressure for carbonized nanospheres (square monikers) absent of a graphene coating, and carbon core-graphene shell nanomaterials of the present invention obtained using a powder resistivity instrument (GM-II, China). The samples were analyzed by placing a certain number of carbon nanomaterial in an insulated cylinder, followed by different pressure to compact the carbon nanomaterial. The conductivity of carbon can be calculated by a the formula of: ρ=VS/Ih, where, ρ is resistivity (μΩm), V is Voltage of sample ends (mV), S is cross-sectional area (mm²), I is the current passing though sample (A), and h is the height of sample (mm). As shown in FIG. 9, the carbon core-graphene shell nanomaterials of the present invention had a higher conductivity at higher pressures as compared to the non-graphene carbonized nanospheres.

It can be seen from FIGS. 8A and 8B, the resultant carbon nanospheres exhibit monodisperse and wrinkled surface, with an average particle diameter of about 200 nm (FIG. 8A). Furthermore, it can be seen from TEM image (FIG. 8B) that a coating layer thickness of about 1 nm can be observed, indicating graphene, as the ‘shield’, can inhibit effectively the cross-linking and melting among nanospheres. However, for non-coating nanospheres, they are aligned one by one to form the lamellar structure, followed by multi-layered spherical structure due to the effect of surface tension.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A method of producing a carbon core-graphene shell material, the method comprising:
(a) obtaining a dispersion comprising a grafted graphene oxide material and a polymerizable carbon material dispersed in a liquid medium;
(b) polymerizing the polymerizable carbon material in the dispersion to obtain a grafted graphene oxide coated polymerized carbon material dispersed in the liquid medium;
(c) evaporating the liquid medium from the dispersion; and
(d) heating the grafted graphene oxide coated polymerized carbon material to obtain the carbon core-graphene shell material.

2. The method of claim 1, wherein the polymerizable carbon material is acrylonitrile (AN), the polymerized carbon material is polyacrylonitrile (PAN), and the carbon core is a PAN-based carbon core.

3. The method of claim 1, wherein the polymerization step (b) comprises combining a polymerization initiator with the dispersion to initiate polymerization of the polymerizable carbon material.

4. The method of claim 3, wherein the polymerization initiator is azobisisobutyronitrile (AIBN), potassium persulfate (K₂S₂O₈), sodium persulfate (Na₂S₂O₈), or benzoyl peroxide, or combinations thereof.

5. The method of claim 1, wherein the evaporation step (c) comprises freeze-drying the dispersion.

6. The method of claim 1, wherein the heating step (d) comprises:
(1) subjecting the graphene oxide coated polymerized carbon material to a temperature of 150° C. to 450° C. in the presence of an oxygen source to oxidize the material; and
(2) subjecting the oxidized material to a temperature of 700° C. to 1500° C. in the presence of an inert gas to obtain the carbon core-graphene shell material.

7. The method of claim 1, wherein:
the polymerizable carbon material is acrylonitrile (AN), the polymerized carbon material is polyacrylonitrile (PAN), and the carbon core is a PAN-based carbon core;
the polymerization step (b) comprises combining a polymerization initiator with the dispersion to initiate polymerization of the AN;
the evaporation step (c) comprises freeze-drying the dispersion; and
the heating step (d) comprises:
(1) subjecting the graphene oxide coated PAN material to a temperature of 150° C. to 450° C. in the presence of an oxygen source to oxidize the material; and
(2) subjecting the oxidized material to a temperature of 700° C. to 1500° C. in the presence of an inert gas to obtain the PAN-based carbon core-graphene shell material.

8. The method of claim 1, wherein the grafted graphene oxide material is a nitrogen-containing grafted graphene oxide material.

9. The method of claim 8, wherein the nitrogen-containing grafted graphene oxide material is an amine or amide-containing grafted graphene oxide material selected from the group consisting of allylamine, vinylamine, 4-(vinyloxy)aniline, N-(2-aminoethyl)acrylamide, N-(3-aminopropyl)acrylamide, N-(6-aminohexyl)acrylamide, and N-(4-aminophenyl)acrylamide.

10. The method of claim 1, wherein the nitrogen containing grafted graphene oxide material is obtained by dissolving graphene oxide and a nitrogen containing grafting agent in a solvent to obtain a solution, and heating the solution to graft the grafting agent to the graphene oxide, and optionally removing the solvent.

11. The method of claim 1, wherein the grafted graphene oxide material in step (a) has a lamellar thickness of 1 to 10 layers and a sheet size of 100 nm to 5000 nm.

12. The method of claim 1, wherein the liquid medium is an N-methyl-2-pyrrolidone (NMP), dimethylformamide (DMF), an alcohol, or any combination thereof.

13. The method of claim 1, wherein the obtained carbon core-graphene shell material is in particulate form comprising a plurality of carbon core-graphene shell nanostructures.

14. The method of claim 13, wherein the plurality of nanostructures are nanospheres having an average diameter of 60 nm to 1000 nm.

15. The method of claim 1, wherein the obtained carbon core-graphene shell material is activated.

16. A carbon core-graphene shell material made by the process of claim 1.

17. The material of claim 16, comprised in an energy storage device, a coating material, or a catalyst for a chemical reaction.

18. A plurality of monodisperse polyacrylonitrile (PAN)-based carbon core-graphene shell nanostructures, each nanostructure comprising a PAN-based carbonized core and a graphene shell that substantially encompasses the core.

19. The plurality of monodisperse PAN-based carbon core-graphene shell nanostructures of claim 18, wherein the nanostructures are comprised in an energy storage device, a coating material, or a catalyst for a chemical reaction.

20. The plurality of monodisperse PAN-based carbon core-graphene shell nanostructures of claim 19, wherein the nanostructures are comprised in an energy storage device.
